(19) United States
(12) Patent Application Publication
(10) Pub. No.: US 2013/0210623 A1
(43) Pub. Date: Aug. 15, 2013

(54) PESTICIDAL MIXTURES INCLUDING ISOXAZOLINE DERIVATIVES

(71) Applicants: Jerome Yves Cassayre, Stein (CH); Elvira Molitor, Stein (CH)

(72) Inventors: Jerome Yves Cassayre, Stein (CH); Elvira Molitor, Stein (CH)

(73) Assignee: SYNGENTA CROP PROTECTION LLC, Greensboro, NC (US)

(21) Appl. No.: 13/702,646

(22) PCT Filed: Jun. 8, 2011
(86) PCT No.: PCT/EP2011/059444

§ 371 Date: Feb. 21, 2013

(30) Foreign Application Priority Data
Jun. 9, 2010 (EP) 10165344.2

(51) Int. Cl. A01N 53/00; A01N 43/78; A01N 47/06; A01N 43/22; A01N 43/80

(52) U.S. Cl. CPC A01N 53/00; A01N 43/22; A01N 43/80; A01N 47/06; A01N 43/78
USPC 504/100; 514/30; 514/378; 514/365

(57) ABSTRACT

The present invention provides pesticidal mixtures comprising a component A and a component B, wherein component A is an enantiomeric mixture of a compound of formula I that is enantiomerically enriched for the S enantiomer (Formula I) wherein the symbol * indicates the chiral centre; wherein A¹, A², R¹, R², R⁴, R⁵, R⁶ and p are as defined in claim 1, and component B is a compound as defined in claim 1. The present invention also relates to methods of using said mixtures for the control of plant pests.

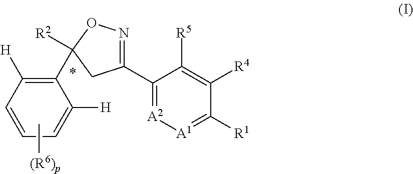

The present invention relates to mixtures of pesticidally active ingredients and to methods of using the mixtures in the field of agriculture.

EP1731512 discloses that certain isoxazoline compounds have insecticidal activity. WO 2010/003877 and WO 2010/003923 disclose various pesticidal mixtures comprising certain isoxazoline compounds.

The present invention provides pesticidal mixtures comprising a component A and a component B, wherein component A is an enantiomeric mixture of a compound of formula I that is enantiomerically enriched for the S enantiomer

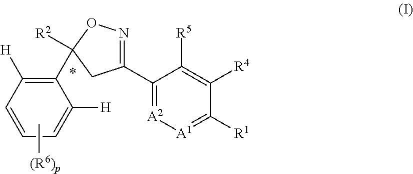

wherein the symbol * indicates the chiral centre;
A¹ and A² are C—H, or one of A¹ and A² is C—H and the other is N;
R¹ is a group selected from P1 to P38

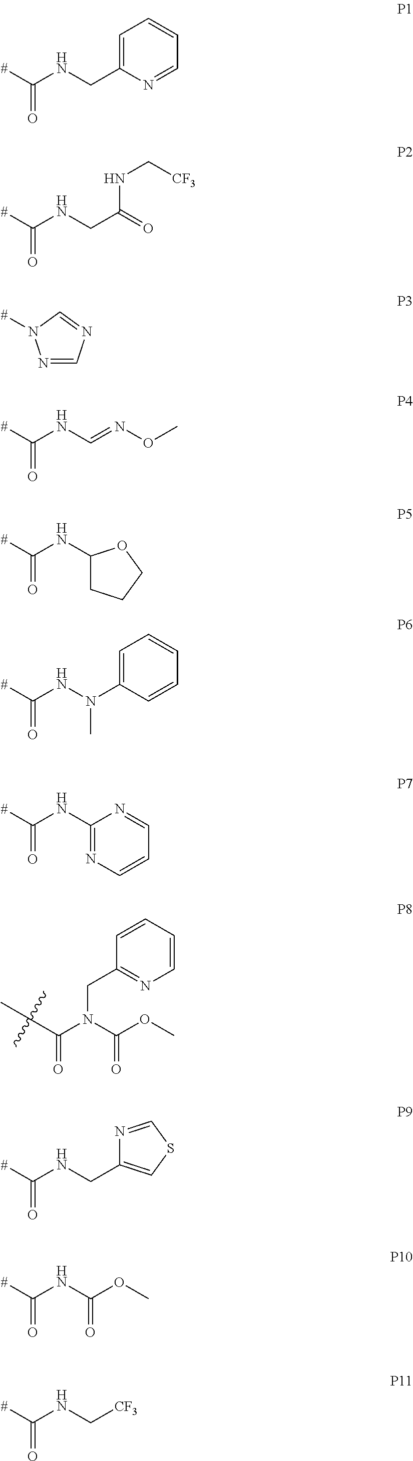

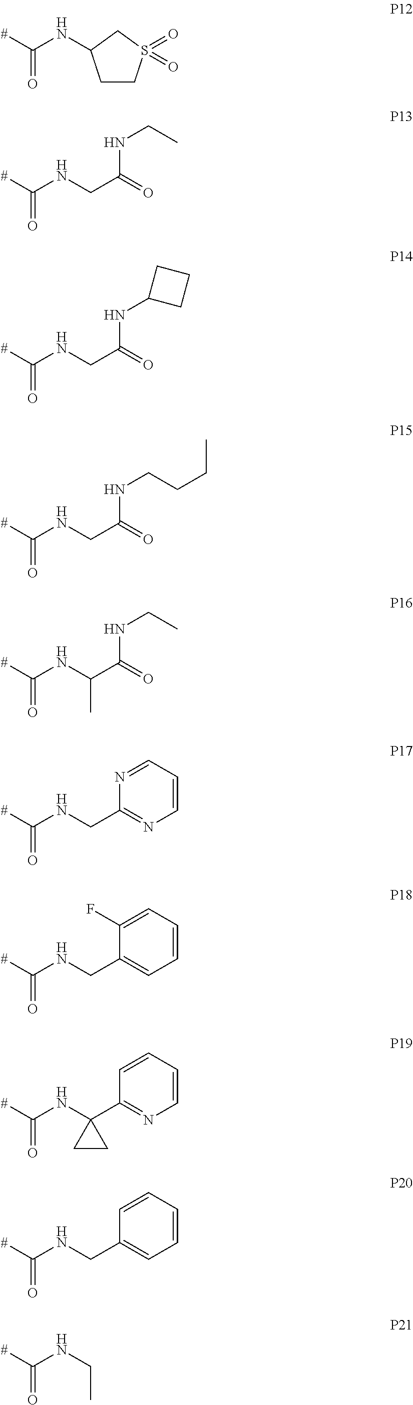

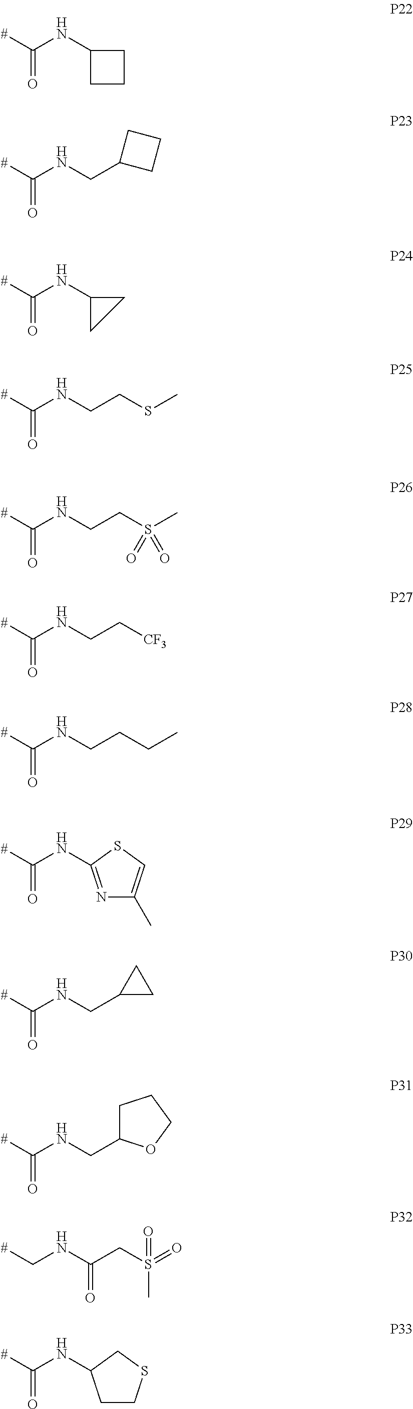

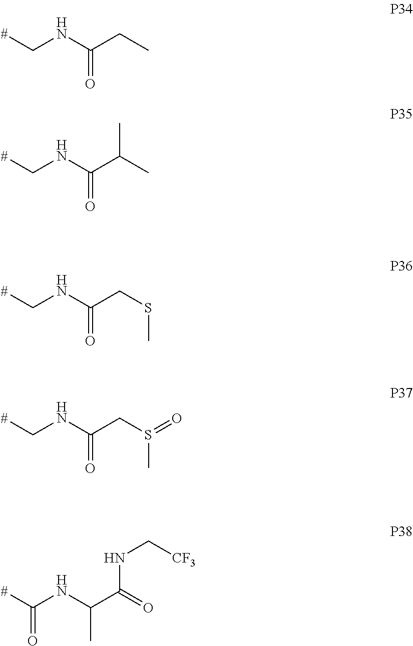

R² is chlorodifluoromethyl or trifluoromethyl;
R⁴ is hydrogen, halogen, methyl, halomethyl or cyano;
R⁵ is hydrogen;
or R⁴ and R⁵ together form a bridging 1,3-butadiene group;
each R⁶ is independently bromo, chloro, fluoro or trifluoromethyl;
p is 2 or 3;
and component B is a compound selected from
a) a pyrethroid including those selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
b) an organophosphate including those selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
c) a carbamate including those selected from the group consisting of pirimicarb, triazamate, cloethocarb, carbofuran, furathiocarb, ethiofencarb, aldicarb, thiofurox, carbosulfan, bendiocarb, fenobucarb, propoxur, methomyl and oxamyl;
d) a benzoyl urea including those selected from the group consisting of diflubenzuron, triflumuron, hexaflumuron, flufenoxuron, lufenuron and chlorfluazuron;
e) an organic tin compound selected from the group consisting of cyhexatin, fenbutatin oxide and azocyclotin;
f) a pyrazole including those selected from the group consisting of tebufenpyrad and fenpyroximate;
g) a macrolide including those selected from the group consisting of abamectin, emamectin (e.g. emamectin benzoate), ivermectin, milbemycin, spinosad, azadirachtin and spinetoram;
h) an organochlorine compound including those selected from the group consisting of endosulfan (in particular alpha-endosulfan), benzene hexachloride, DDT, chlordane and dieldrin;
i) an amidine including those selected from the group consisting of chlordimeform and amitraz;
j) a fumigant agent including those selected from the group consisting of chloropicrin, dichloropropane, methyl bromide and metam;
k) a neonicotinoid compound including those selected from the group consisting of imidacloprid, thiacloprid, acetamiprid, nitenpyram, dinotefuran, thiamethoxam, clothianidin, nithiazine and flonicamid;
l) a diacylhydrazine including those selected from the group consisting of tebufenozide, chromafenozide and methoxyfenozide;
m) a diphenyl ether including those selected from the group consisting of diofenolan and pyriproxyfen;
n) indoxacarb;
o) chlorfenapyr;
p) pymetrozine;
q) a tetramic acid compound including those selected from the group consisting of spirotetramat and spirodiclofen, or a tetronic acid compound including including spiromesifen;
r) a diamide including those selected from the group consisting of flubendiamide, chlorantraniliprole (Rynaxypyr®) and cyantraniliprole;
s) sulfoxaflor;
t) metaflumizone;
u) fipronil and ethiprole;
v) pyrifluqinazon;
w) buprofezin;
x) diafenthiuron; and
y) 4-[(6-Chloro-pyridin-3-ylmethyl)-(2,2-difluoro-ethyl)-amino]-5H-furan-2-one.

Compounds in ground a)-y) are insecticidal compounds. In addition, component B may be a nematicidally active biological agent. The nematicidally active biological agent refers to any biological agent that has nematicidal activity. The biological agent can be any type known in the art including bacteria and fungi. The wording “nematicidally active” refers to having an effect on, such as reduction in damage caused by, agricultural-related nematodes. The nematicidally active biological agent can be a bacterium or a fungus. Preferably, the biological agent is a bacterium. Examples of nematicidally active bacteria include Bacillus firmus, Bacillus cereus, Bacillus subtilis, and Pasteuria penetrans, preferably Bacillus firmus, Bacillus subtilis, and Pasteuria penetrans. A suitable Bacillus firmus strain is strain CNCM I-1582 which is commercially available as BioNem™. A suitable Bacillus cereus strain is strain CNCM I-1562. Of both Bacillus strains more details can be found in U.S. Pat. No. 6,406,690.

Compounds of formula I are known to have insecticidal activity. Certain active ingredient mixtures of a compound of formula I and additional active ingredients can enhance the spectrum of action with respect to the pest to be controlled, For example, the combination of A and B may cause an increase in the expected insecticidal action. This allows, on the one hand, a substantial broadening of the spectrum of pests that can be controlled and, on the other hand, increased safety in use through lower rates of application.

However, besides the actual synergistic action with respect to pest control, the pesticidal compositions according to the invention can have further surprising advantageous properties which can also be described, in a wider sense, as synergistic activity. Examples of such advantageous properties that may be mentioned are: a broadening of the spectrum of pest control to other pests, for example to resistant strains; a reduction in the rate of application of the active ingredients; adequate pest control with the aid of the compositions according to the invention, even at a rate of application at which the individual compounds are totally ineffective; advantageous behaviour during formulation and/or upon application, for example upon grinding, sieving, emulsifying, dissolving or dispensing; increased storage stability; improved stability to light; more advantageuos degradability; improved toxicological and/or ecotoxicological behaviour; improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination; or any other advantages familiar to a person skilled in the art.

Compounds of formula I as racemic mixtures are known e.g. EP1731512, WO 2010/003877 and WO 2010/003923. Methods of preparing enantiomerically enriched mixtures are described for example in WO 2009/063910. The components B are known, e.g. from “The Pesticide Manual”, Fifteenth Edition, Edited by Clive Tomlin, British Crop Protection Council.

The combinations according to the invention may also comprise more than one of the active components B, if, for example, a broadening of the spectrum of pest control is desired. For instance, it may be advantageous in the agricultural practice to combine two or three components B with any of the compounds of formula I, or with any preferred member of the group of compounds of formula I. The mixtures of the invention may also comprise other active ingredients in addition to components A and B. In other embodiments the mixtures of the invention may include only components A and B as pesticidally active ingredients, e.g. no more than two pesticidally active ingredients.

Preferred substituents are, in any combination, as set out below.

A¹ and A² are preferably C—H.
R¹ is preferably a group selected from P1 to P11, more preferably P1 or P2, most preferably P2.
R² is preferably trifluoromethyl.
R⁴ is preferably chloro, bromo, CF₃, methyl or —CN, more preferably R⁴ is methyl when
R¹ is a group other than P3 and R⁴ is —CN when R⁴ is P3.
R⁵ is preferably hydrogen.
each R⁶ is preferably chlorine.
p is preferably 2.

Each substituent definition in each preferred group of compounds of formula I may be juxtaposed with any substituent definition in any other preferred group of compounds, in any combination.

Compounds of formula I include at least one chiral centre and may exist as compounds of formula I* or compounds of formula I**.

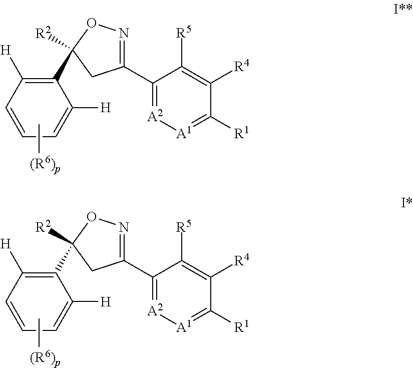

Generally compounds of formula I** (i.e. the S enantiomer) are more biologically active than compounds of formula I* (i.e. the R enantiomer).

Component A according to the invention is an enantiomeric mixture that is enantiomerically enriched for the compound of formula I**. Enantiomerically enriched means that the molar proportion of one enantiomer in the mixture compared to the total amount of both enantiomers is greater than 50%, e.g. at least 55, 60, 65, 70, 75, 80, 85, 90, 95, 96, 97, 98, or least 99%. In one embodiment component A is a compound of formula I** in substantially pure form, e.g. it is provided substantially in the absence of the alternative enantiomer.

The mixtures of the invention do not contain any compounds of formula I in addition to component A. In other words, the molar amount of compound of formula I** in the mixtures of the invention is greater than the molar amount of the compounds of formula I*. The invention also provides mixtures consisting of component A and component B in addition to customary formulation ingredients, e.g. an agriculturally acceptable carrier and optionally a surfactant.

In one group of compounds component A is a compound of formula IA

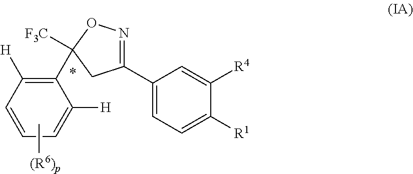

wherein the symbol * indicates the chiral centre;

### R¹ is P1 or P2;

R⁴ is chloro, bromo, CF₃ or methyl;
each R⁶ is independently bromo, chloro, fluoro or trifluoromethyl; and
p is 2 or 3.

Preferred compounds of formula I are shown in the Table below.

TABLE A
Compounds of formula (I-A)
(I-A)

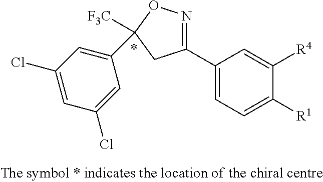

| No. | Stereochemistry at * | R4 | R1 |
|---|---|---|---|
| 1 | S | Me | P1 |
| 2 | S | Me | P2 |
| 3 | S | —CN | P3 |
| 4 | S | Me | P4 |
| 5 | S | Me | P5 |
| 6 | S | Me | P6 |
| 7 | S | Me | P7 |
| 8 | S | Me | P8 |
| 9 | S | Me | P9 |
| 10 | S | Me | P10 |
| 11 | S | Me | P11 |
| 12 | S | Me | P12 |
| 13 | S | Me | P13 |
| 14 | S | Me | P14 |
| 15 | S | Me | P15 |
| 16 | S | Me | P16 |
| 17 | S | Me | P17 |
| 18 | S | Me | P18 |
| 19 | S | Me | P19 |
| 20 | S | Me | P20 |
| 21 | S | Me | P21 |
| 22 | S | Me | P22 |
| 23 | S | Me | P23 |
| 24 | S | Me | P24 |
| 25 | S | Me | P25 |
| 26 | S | Me | P26 |
| 27 | S | Me | P27 |
| 28 | S | Me | P28 |
| 29 | S | Me | P29 |
| 30 | S | Me | P30 |
| 31 | S | Me | P31 |
| 32 | S | Me | P32 |
| 33 | S | Me | P33 |
| 34 | S | Me | P34 |
| 35 | S | Me | P35 |
| 36 | S | Me | P36 |
| 37 | S | Me | P37 |
| 38 | S | Me | P38 |

Bearing in mind the chiral centre referred to above, the present invention otherwise includes all isomers of compounds of formula (I) and salts thereof, including enantiomers, diastereomers and tautomers. The invention also includes N-oxides.

The present invention provides pesticidal mixtures comprising a component A and a component B, wherein component A is an enantiomeric mixture of a compound of formula IB that is enantiomerically enriched for the S enantiomer

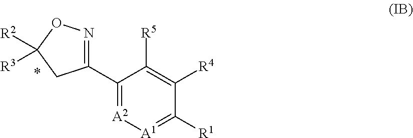

wherein the symbol * indicates the chiral centre;
A¹ and A² are C—H, or one of A¹ and A² is C—H and the other is N;
R¹ is a group selected from P1 to P11;
R² is chlorodifluoromethyl or trifluoromethyl;
R³ is 3,5-dibromo-phenyl, 3,5-dichloro-phenyl, 3,4-dichloro-phenyl, 3,5-dichloro-4-fluoro-phenyl or 3,4,5-trichloro-phenyl;
R⁴ is hydrogen, methyl or cyano;
R⁵ is hydrogen;
or R⁴ and R⁵ together form a bridging 1,3-butadiene group;
and component B is as defined herein.

The preferred definitions of A¹, A², R¹, R², R⁴, and R⁵ are as defined for compound of formula I. R³ is preferably 3,5-dichloro-phenyl or 3,4,5-trichlorophenyl.

In one embodiment component B is a compound selected from

a) a pyrethroid selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
b) an organophosphate selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
c) a carbamate selected from the group consisting of pirimicarb, triazamate, cloethocarb, carbofuran, furathiocarb, ethiofencarb, aldicarb, thiofurox, carbosulfan, bendiocarb, fenobucarb, propoxur, methomyl and oxamyl;
d) a benzoyl urea selected from the group consisting of diflubenzuron, triflumuron, hexaflumuron, flufenoxuron, lufenuron and chlorfluazuron;
f) an organic tin compound selected from the group consisting of cyhexatin, fenbutatin oxide and azocyclotin;
f) a pyrazole selected from the group consisting of tebufenpyrad and fenpyroximate;
g) a macrolide selected from the group consisting of abamectin, emamectin (e.g. emamectin benzoate), ivermectin, milbemycin, spinosad, azadirachtin and spinetoram;
h) an organochlorine compound selected from the group consisting of endosulfan (in particular alpha-endosulfan), benzene hexachloride, DDT, chlordane and dieldrin;
i) an amidine selected from the group consisting of chlordimeform and amitraz;
j) a fumigant agent selected from the group consisting of chloropicrin, dichloropropane, methyl bromide and metam;
k) a neonicotinoid compound selected from the group consisting of imidacloprid, thiacloprid, acetamiprid, nitenpyram, dinotefuran, thiamethoxam, clothianidin, nithiazine and flonicamid;
l) a diacylhydrazine selected from the group consisting of tebufenozide, chromafenozide and methoxyfenozide;
m) a diphenyl ether selected from the group consisting of diofenolan and pyriproxyfen;
n) indoxacarb;
o) chlorfenapyr;
p) pymetrozine;
q) spirotetramat spirodiclofen or spiromesifen;
r) a diamide selected from the group consisting of flubendiamide, chlorantraniliprole (Rynaxypyr®) and cyantraniliprole;
s) sulfoxaflor;
t) metaflumizone;
u) fipronil and ethiprole;
v) pyrifluqinazon; and
w) buprofezin.
x) diafenthiuron; and
y) 4-[(6-Chloro-pyridin-3-ylmethyl)-(2,2-difluoro-ethyl)-amino]-5H-furan-2-one.

In one embodiment of the invention component B is a compound selected from the group consisting of
pymetrozine;
an organophosphate selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
a pyrethroid selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
a macrolide selected from the group consisting of abamectin, emamectin benzoate, ivermectin, milbemycin, spinosad, azadirachtin and spinetoram;
a diamide selected from the group consisting of flubendiamide, chlorantraniliprole (Rynaxypyr®) and cyantraniliprole;
a neonicotinoid compound selected from the group consisting of imidacloprid, thiacloprid, acetamiprid, nitenpyram, dinotefuran, thiamethoxam, clothianidin, nithiazine and flonicamid; and
spirotetramat, spirodiclofen and spiromesifen.

In one embodiment of the invention component B is a compound selected from the group consisting of abamectin, chlorpyrifos, cyantraniliprole, emamectin, lambda cyhalothrin, pymetrozine, spirotetramat, thiamethoxam, clothianidin, imidacloprid and chlorantraniliprole.

In one embodiment of the invention component B is a compound selected from the group consisting of abamectin, chlorpyrifos, cyantraniliprole, emamectin, lambda cyhalothrin, pymetrozine, spirotetramat, and thiamethoxam.

In one embodiment of the invention component B is a compound selected from the group consisting of
a macrolide compound including those selected from the group consisting of abamectin, emamectin (e.g. emamectin benzoate), ivermectin, milbemycin, spinosad, azadirachtin and spinetoram;
a neonicotinoid compound including those selected from the group consisting of imidacloprid, thiacloprid, acetamiprid, nitenpyram, dinotefuran, thiamethoxam, clothianidin, nithiazine and flonicamid;
a pyrethroid compound including those selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
a tetramic acid compound including those selected from the group consisting of spirotetramat and spirodiclofen.

In one embodiment of the invention component B is a compound selected from the group consisting of abamectin, lambda cyhalothrin, spirotetramat and clothianidin. In one embodiment component B is abamectin. In one embodiment component B is lambda cyhalothrin. In one embodiment component B is spirotetramat. In one embodiment component B is clothianidin.

In one embodiment of the invention component B is a tetramic acid compound including those selected from spirotetramat and spirodiclofen, e.g. spirotetramat or spirodiclofen, preferably spirotetramat.

The invention also includes the following combinations:

A mixture of a compound from Table A and abamectin.
A mixture of a compound from Table A and chlorpyrifos.
A mixture of a compound from Table A and cyantraniliprole.
A mixture of a compound from Table A and emamectin.
A mixture of a compound from Table A and cyhalothrin.
A mixture of a compound from Table A and lambda cyhalothrin.
A mixture of a compound from Table A and gamma cyhalothrin.
A mixture of a compound from Table A and pymetrozine.
A mixture of a compound from Table A and spirotetramat.
A mixture of a compound from Table A and thiamethoxam.
A mixture of a compound from Table A and chlorantraniliprole.
A mixture of a compound from Table A and profenofos.
A mixture of a compound from Table A and acephate.
A mixture of a compound from Table A and azinphos-methyl.
A mixture of a compound from Table A and methamidophos.
A mixture of a compound from Table A and spinosad.
A mixture of a compound from Table A and spinetoram.
A mixture of a compound from Table A and flonicamid.
A mixture of a compound from Table A and indoxacarb.
A mixture of a compound from Table A and spirodiclofen.
A mixture of a compound from Table A and spiromesifen.
A mixture of a compound from Table A and sulfoxaflor.
A mixture of a compound from Table A and fipronil.
A mixture of a compound from Table A and imidacloprid.
A mixture of a compound from Table A and thiacloprid.
A mixture of a compound from Table A and acetamiprid.
A mixture of a compound from Table A and nitenpyram.
A mixture of a compound from Table A and dinotefuran.
A mixture of a compound from Table A and clothianidin.
A mixture of a compound from Table A and nithiazine.
A mixture of a compound from Table A and pyriproxyfen.
A mixture of a compound from Table A and buprofezin.
A mixture of a compound from Table A and pyrifluqinazon.
A mixture of a compound from Table A, thiamethoxam and cyantraniliprole.
A mixture of a compound from Table A, thiamethoxam and chlorantraniliprole.
A mixture of a compound from Table A and sulfoxaflor.
A mixture of a compound from Table A and Lufeneron.
A mixture of a compound from Table A and Diafenthiuron.
A mixture of a compound from Table A and Flubendiamide.
A mixture of a compound from Table A and Tefluthrin.
A mixture of a compound from Table A and Fipronil.

The present invention also relates to a method of controlling insects, acarines, nematodes or molluscs which comprises applying to a pest, to a locus of a pest, or to a plant susceptible to attack by a pest a combination of components A and B; seeds comprising a mixture of components A and B; and a method comprising coating a seed with a mixture of components A and B.

The present invention also includes pesticidal mixtures comprising a component A and a component B in a synergistically effective amount; agricultural compositions comprising a mixture of component A and B in a synergistically effective amount; the use of a mixture of component A and B in a synergistically effective amount for combating animal pests; a method of combating animal pests which comprises contacting the animal pests, their habit, breeding ground, food supply, plant, seed, soil, area, material or environment in which the animal pests are growing or may grow, or the materials, plants, seeds, soils, surfaces or spaces to be protected from animal attack or infestation with a mixture of component A and B in a synergistically effective amount; a method for protecting crops from attack or infestation by animal pests which comprises contacting a crop with a mixture of component A and B in a synergistically effective amount; a method for the protection of seeds from soil insects and of the seedlings' roots and shoots from soil and foliar insects comprising contacting the seeds before sowing and/or after pre-germination with a mixture of component A and B in a synergistically effective amount; seeds comprising, e.g. coated with, a mixture of component A and B in a synergistically effective amount; a method comprising coating a seed with a mixture of component A and B in a synergistically effective amount; a method of controlling insects, acarines, nematodes or molluscs which comprises applying to a pest, to a locus of a pest, or to a plant susceptible to attack by a pest a combination of components A and B in a synergistically effective amount. Mixtures of A and B will normally be applied in an insecticidally, acaricidally, nematicidally or molluscicidally effective amount. In application components A and B may be applied simultaneously or separately.

The mixtures of the present invention can be used to control infestations of insect pests such as Lepidoptera, Diptera, Hemiptera, Thysanoptera, Orthoptera, Dictyoptera, Coleoptera, Siphonaptera, Hymenoptera and Isoptera and also other invertebrate pests, for example, acarine, nematode and mollusc pests. Insects, acarines, nematodes and molluscs are herein collectively referred to as pests. The pests which may be controlled by the use of the invention compounds include those pests associated with agriculture (which term includes the growing of crops for food and fiber products), horticulture and animal husbandry, companion animals, forestry and the storage of products of vegetable origin (such as fruit, grain and timber); those pests associated with the damage of man-made structures and the transmission of diseases of man and animals; and also nuisance pests (such as flies). The mixtures of the invention are particularly effective against insects, acarines and/or nematodes.

According to the invention “useful plants” typically comprise the following species of plants: grape vines; cereals, such as wheat, barley, rye or oats; beet, such as sugar beet or fodder beet; fruits, such as pomes, stone fruits or soft fruits, for example apples, pears, plums, peaches, almonds, cherries, strawberries, raspberries or blackberries; leguminous plants, such as beans, lentils, peas or soybeans; oil plants, such as rape, mustard, poppy, olives, sunflowers, coconut, castor oil plants, cocoa beans or groundnuts; cucumber plants, such as marrows, cucumbers or melons; fibre plants, such as cotton, flax, hemp or jute; citrus fruit, such as oranges, lemons, grapefruit or mandarins; vegetables, such as spinach, lettuce, asparagus, cabbages, carrots, onions, tomatoes, potatoes, cucurbits or paprika; lauraceae, such as avocados, cinnamon or camphor; maize; tobacco; nuts; coffee; sugar cane; tea; vines; hops; durian; bananas; natural rubber plants; turf or ornamentals, such as flowers, shrubs, broad-leaved trees or evergreens, for example conifers. This list does not represent any limitation.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins, for example insecticidal proteins from Bacillus cereus or Bacillus popliae; or insecticidal proteins from Bacillus thuringiensis, such as δ-endotoxins, e.g. CryIA(b), CryIA(c), CryIF, CryIF(a2), CryIIA(b), CryIIIA, CryIIIB(b1) or Cry9c, or vegetative insecticidal proteins (VIP), e.g. VIP1, VIP2, VIP3 or VIP3A; or insecticidal proteins of bacteria colonising nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsine inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by δ-endotoxins, for example CryIA(b), CryIA(c), CryIF, CryIF(a2), CryIIA(b), CryIIIA, CryIIIB(b1) or Cry9c, or vegetative insecticidal proteins (VIP), for example VIP1, VIP2, VIP3 or VIP3A, expressly also hybrid toxins, truncated toxins and modified toxins. Hybrid toxins are produced recombinantly by a new combination of different domains of those proteins (see, for example, WO 02/15701). An example for a truncated toxin is a truncated CryIA(b), which is expressed in the Bt11 maize from Syngenta Seed SAS, as described below. In the case of modified toxins, one or more amino acids of the naturally occurring toxin are replaced. In such amino acid replacements, preferably non-naturally present protease recognition sequences are inserted into the toxin, such as, for example, in the case of CryIIIA055, a cathepsin-D-recognition sequence is inserted into a CryIIIA toxin (see WO 03/018810)

Examples of such toxins or transgenic plants capable of synthesising such toxins are disclosed, for example, in EP-A-0 374 753, WO 93/07278, WO 95/34656, EP-A-0 427 529, EP-A-451 878 and WO 03/052073.

The processes for the preparation of such transgenic plants are generally known to the person skilled in the art and are described, for example, in the publications mentioned above. CryI-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and butterflies (Lepidoptera).

Transgenic plants containing one or more genes that code for an insecticidal resistance and express one or more toxins are known and some of them are commercially available. Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); NatureGard® and Protecta®.

Further examples of such transgenic crops are:

1. Bt11 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated CryIA(b) toxin. Bt11 maize also transgenically expresses the enzyme PAT to achieve tolerance to the herbicide glufosinate ammonium.
2. Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a CryIA(b) toxin. Bt176 maize also transgenically expresses the enzyme PAT to achieve tolerance to the herbicide glufosinate ammonium.
3. MIR604 Maize from Syngenta Seeds SAS, Chemin de l'Hobit 27, F-31 790 St. Sauveur, France, registration number C/FR/96/05/10. Maize which has been rendered insect-resistant by transgenic expression of a modified CryIIIA toxin. This toxin is Cry3A055 modified by insertion of a cathepsin-D-protease recognition sequence. The preparation of such transgenic maize plants is described in WO 03/018810.
4. MON 863 Maize from Monsanto Europe S.A. 270-272 Avenue de Tervuren, B-1150 Brussels, Belgium, registration number C/DE/02/9. MON 863 expresses a CryIIIB(b1) toxin and has resistance to certain Coleoptera insects.
5. IPC 531 Cotton from Monsanto Europe S.A. 270-272 Avenue de Tervuren, B-1150 Brussels, Belgium, registration number C/ES/96/02.
6. 1507 Maize from Pioneer Overseas Corporation, Avenue Tedesco, 7 B-1160 Brussels, Belgium, registration number C/NL/00/10. Genetically modified maize for the expression of the protein CryIF for achieving resistance to certain Lepidoptera insects and of the PAT protein for achieving tolerance to the herbicide glufosinate ammonium.
7. NK603×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a CryIA(b) toxin obtained from Bacillus thuringiensis subsp. kurstaki which brings about tolerance to certain Lepidoptera, include the European corn borer.

Transgenic crops of insect-resistant plants are also described in BATS (Zentrum für Biosicherheit and Nachhaltigkeit, Zentrum BATS, Clarastrasse 13, 4058 Basel, Switzerland) Report 2003, (http://bats.ch).

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906).

Useful plants of elevated interest in connection with present invention are cereals; soybean; rice; oil seed rape; pome fruits; stone fruits; peanuts; coffee; tea; strawberries; turf; vines and vegetables, such as tomatoes, potatoes, cucurbits and lettuce.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of a plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds. Insecticides that are of particular interest for treating seeds include thiamethoxam, imidacloprid and clothianidin. Accordingly, in one embodiment component B is selected from thiamethoxam, imidacloprid and clothianidin.

A further aspect of the instant invention is a method of protecting natural substances of plant and/or animal origin, which have been taken from the natural life cycle, and/or their processed forms against attack of pests, which comprises applying to said natural substances of plant and/or animal origin or their processed forms a combination of components A and B in a synergistically effective amount.

According to the instant invention, the term “natural substances of plant origin, which have been taken from the natural life cycle” denotes plants or parts thereof which have been harvested from the natural life cycle and which are in the freshly harvested form. Examples of such natural substances of plant origin are stalks, leafs, tubers, seeds, fruits or grains. According to the instant invention, the term “processed form of a natural substance of plant origin” is understood to denote a form of a natural substance of plant origin that is the result of a modification process. Such modification processes can be used to transform the natural substance of plant origin in a more storable form of such a substance (a storage good). Examples of such modification processes are pre-drying, moistening, crushing, comminuting, grounding, compressing or roasting. Also falling under the definition of a processed form of a natural substance of plant origin is timber, whether in the form of crude timber, such as construction timber, electricity pylons and barriers, or in the form of finished articles, such as furniture or objects made from wood.

According to the instant invention, the term “natural substances of animal origin, which have been taken from the natural life cycle and/or their processed forms” is understood to denote material of animal origin such as skin, hides, leather, furs, hairs and the like.

A preferred embodiment is a method of protecting natural substances of plant origin, which have been taken from the natural life cycle, and/or their processed forms against attack of pests, which comprises applying to said natural substances of plant and/or animal origin or their processed forms a combination of components A and B in a synergistically effective amount.

A further preferred embodiment is a method of protecting fruits, preferably pomes, stone fruits, soft fruits and citrus fruits, which have been taken from the natural life cycle, and/or their processed forms, which comprises applying to said fruits and/or their processed forms a combination of components A and B in a synergistically effective amount.

The combinations according to the present invention are furthermore particularly effective against the following pests: Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Boophilus microplus (cattle tick), Dermacentor variabilis (American dog tick), Ctenocephalides felis (cat flea), Liriomyza spp. (leafminer), Musca domestica (housefly), Aedes aegypti (mosquito), Anopheles spp. (mosquitoes), Culex spp. (mosquitoes), Lucillia spp. (blowflies), Blattella germanica (cockroach), Periplaneta americana (cockroach), Blatta orientalis (cockroach), termites of the Mastotermitidae (for example Mastotermes spp.), the Kalotermitidae (for example Neotermes spp.), the Rhinotermitidae (for example Coptotermes formosanus, Reticulitermes flavipes, R. speratu, R. virginicus, R. hesperus, and R. santonensis) and the Termitidae (for example Globitermes sulfureus), Solenopsis geminata (fire ant), Monomorium pharaonis (pharaoh's ant), Damalinia spp. and Linognathus spp. (biting and sucking lice), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug).

The amount of a combination of the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic; the type of pest to be controlled or the application time.

The mixtures comprising a compound of formula I, e.g. those selected from table A, and one or more active ingredients as described above can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the compounds of formula I selected from table A and the active ingredients as described above is not essential for working the present invention.

The synergistic activity of the combination is apparent from the fact that the pesticidal activity of the composition of A+B is greater than the sum of the pesticidal activities of A and B.

The method of the invention comprises applying to the useful plants, the locus thereof or propagation material thereof in admixture or separately, a synergistically effective aggregate amount of a component A and a component B.

Some of said combinations according to the invention have a systemic action and can be used as foliar, soil and seed treatment pesticides.

With the combinations according to the invention it is possible to inhibit or destroy the pests which occur in plants or in parts of plants (fruit, blossoms, leaves, stems, tubers, roots) in different useful plants, while at the same time the parts of plants which grow later are also protected from attack by pests.

The combinations of the present invention are of particular interest for controlling pests in various useful plants or their seeds, especially in field crops such as potatoes, tobacco and sugarbeets, and wheat, rye, barley, oats, rice, maize, lawns, cotton, soybeans, oil seed rape, pulse crops, sunflower, coffee, sugarcane, fruit and ornamentals in horticulture and viticulture, in vegetables such as cucumbers, beans and cucurbits.

The combinations according to the invention are applied by treating the pests, the useful plants, the locus thereof, the propagation material thereof, the natural substances of plant and/or animal origin, which have been taken from the natural life cycle, and/or their processed forms, or the industrial materials threatened by pests, attack with a combination of components A and B in a synergistically effective amount.

The combinations according to the invention may be applied before or after infection or contamination of the useful plants, the propagation material thereof, the natural substances of plant and/or animal origin, which have been taken from the natural life cycle, and/or their processed forms, or the industrial materials by the pests.

The combinations according to the invention can be used for controlling, i.e. containing or destroying, pests of the abovementioned type which occur on useful plants in agriculture, in horticulture and in forests, or on organs of useful plants, such as fruits, flowers, foliage, stalks, tubers or roots, and in some cases even on organs of useful plants which are formed at a later point in time remain protected against these pests.

When applied to the useful plants the compound of formula I is generally applied at a rate of 1 to 500 g a.i./ha in association with 1 to 2000 g a.i./ha, of a compound of component B, depending on the class of chemical employed as component B.

Generally for plant propagation material, such as seed treatment, application rates can vary from 0.001 to 10 g/kg of seeds of active ingredients. When the combinations of the present invention are used for treating seed, rates of 0.001 to 5 g of a compound of formula I per kg of seed, preferably from 0.01 to 1 g per kg of seed, and 0.001 to 5 g of a compound of component B, per kg of seed, preferably from 0.01 to 1 g per kg of seed, are generally sufficient.

The weight ratio of A to B may generally be between 1000:1 and 1:1000. In other embodiments that weight ratio of A to B may be between 500:1 to 1:500, for example between 100:1 to 1:100, for example between 1:50 to 50:1, for example 1:20 to 20:1.

The invention also provides pesticidal mixtures comprising a combination of components A and B as mentioned above in a synergistically effective amount, together with an agriculturally acceptable carrier, and optionally a surfactant.

Spodoptera preferably means Spodoptera littoralis. Heliothis preferably means Heliothis virescens. Tetranychus preferably means Tetranychus urticae.

The compositions of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP), a soluble granule (SG) or any technically feasible formulation in combination with agriculturally acceptable adjuvants.

Such compositions may be produced in conventional manner, e.g. by mixing the active ingredients with appropriate formulation inerts (diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

A seed dressing formulation is applied in a manner known per se to the seeds employing the combination of the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules. A typical a tank-mix formulation for seed treatment application comprises 0.25 to 80%, especially 1 to 75%, of the desired ingredients, and 99.75 to 20%, especially 99 to 25%, of a solid or liquid auxiliaries (including, for example, a solvent such as water), where the auxiliaries can be a surfactant in an amount of 0 to 40%, especially 0.5 to 30%, based on the tank-mix formulation. A typical pre-mix formulation for seed treatment application comprises 0.5 to 99.9%, especially 1 to 95%, of the desired ingredients, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least the compound of formula I together with a compound of component B, and optionally other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

### EXAMPLES

A synergistic effect exists whenever the action of an active ingredient combination is greater than the sum of the actions of the individual components.

The action to be expected E for a given active ingredient combination obeys the so-called COLBY formula and can be calculated as follows (COLBY, S.R. “Calculating synergistic and antagonistic responses of herbicide combination”. Weeds, Vol. 15, pages 20-22; 1967):

ppm=milligrams of active ingredient (=a.i.) per liter of spray mixture
X=% action by active ingredient A) using p ppm of active ingredient
Y=% action by active ingredient B) using q ppm of active ingredient.

According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms the synergism factor SF corresponds to O/E. In the agricultural practice an SF of ≧1.2 indicates significant improvement over the purely complementary addition of activities (expected activity), while an SF of ≦0.9 in the practical application routine signals a loss of activity compared to the expected activity.

Tables 1 to 8 show mixtures and compositions of the present invention demonstrating control on a wide range of invertebrate pests, some with notable synergistic effect. As the percent of mortality cannot exceed 100 percent, the unexpected increase in insecticidal activity can be greatest only when the separate active ingredient components alone are at application rates providing considerably less than 100 percent control. Synergy may not be evident at low application rates where the individual active ingredient components alone have little activity. However, in some instances high activity was observed for combinations wherein individual active ingredient alone at the same application rate had little activity. The synergism is remarkable. Noteworthy are mixtures comprising IA2 and abamectin, I-A2 and lambda cyhalothrin, I-A2 and chlothianidin, I-A2 and spirotetramat.

Heliothis virescens (Tobacco Budworm)

Eggs (0-24 h old) are placed in 24-well microtiter plate on artificial diet and treated with test solutions (DMSO) by pipetting. After an incubation period of 4 days, samples are checked for larval mortality. Application rates are as indicated in the Tables.

TABLE 1

| PPM AI | | AVERAGE DEAD IN % | | EX- | OB- |
|---|---|---|---|---|---|
| COM- | | COM- | | PECTED | SERVED |
| POUND | | POUND | | CON- | CON- |
| I-A2 | Abamectin | I-A2 | Abamectin | TROL | TROL |
| 0.2 | 3.2 | 75 | 90 | 98 | 90 |
| 0.1 | 1.6 | 5 | 90 | 91 | 90 |
| 0.05 | 0.8 | 0 | 65 | 65 | 40 |
| 0.025 | 0.4 | 0 | 10 | 10 | 20 * |
| 0.2 | 1.6 | 75 | 90 | 98 | 85 |
| 0.1 | 0.8 | 5 | 65 | 67 | 85 * |
| 0.05 | 0.4 | 0 | 10 | 10 | 10 |
| 0.2 | 0.8 | 75 | 65 | 91 | 85 |
| 0.1 | 0.4 | 5 | 10 | 15 | 65 * |
| 0.4 | 0.8 | 94 | 65 | 98 | 90 |
| 0.2 | 0.4 | 75 | 10 | 78 | 80 * |
| 0.1 | 0.2 | 5 | 0 | 5 | 0 |
| 0.8 | 0.8 | 99 | 65 | 100 | 100 * |
| 0.4 | 0.4 | 94 | 10 | 94 | 90 |
| 0.2 | 0.2 | 75 | 0 | 75 | 0 |
| 0.1 | 0.1 | 5 | 0 | 5 | 35 * |

TABLE 2

| PPM AI | | AVERAGE DEAD IN % | | EX- | OB- |
|---|---|---|---|---|---|
| COM- | Lambda | COM- | Lambda | PECTED | SERVED |
| POUND | Cyhal- | POUND | Cyhal- | CON- | CON- |
| I-A2 | othrin | I-A2 | othrin | TROL | TROL |
| 0.2 | 0.4 | 75 | 90 | 98 | 95 |
| 0.1 | 0.2 | 5 | 80 | 81 | 88 * |
| 0.05 | 0.1 | 0 | 50 | 50 | 50 |
| 0.025 | 0.05 | 0 | 0 | 0 | 10 * |
| 0.2 | 0.2 | 75 | 80 | 95 | 85 |
| 0.1 | 0.1 | 5 | 50 | 53 | 55 * |
| 0.05 | 0.05 | 0 | 0 | 0 | 20 * |
| 0.2 | 0.1 | 75 | 50 | 88 | 95 * |
| 0.1 | 0.05 | 5 | 0 | 5 | 65 * |
| 0.4 | 0.1 | 94 | 50 | 97 | 93 |
| 0.2 | 0.05 | 75 | 0 | 75 | 80 * |
| 0.8 | 0.1 | 99 | 50 | 99 | 93 |
| 0.4 | 0.05 | 94 | 0 | 94 | 90 |
| 0.2 | 0.025 | 75 | 0 | 75 | 0 |
| 0.1 | 0.0125 | 5 | 0 | 5 | 40 * |

TABLE 3

| PPM AI | | AVERAGE DEAD IN % | | EX- | OB- |
|---|---|---|---|---|---|
| COM- | | COM- | | PECTED | SERVED |
| POUND | Spiro- | POUND | Spiro- | CON- | CON- |
| I-A2 | tetramat | I-A2 | tetramat | TROL | TROL |
| 0.2 | 800 | 73 | 80 | 95 | 93 |
| 0.1 | 400 | 0 | 15 | 15 | 85 * |
| 0.2 | 400 | 73 | 15 | 77 | 85 * |
| 0.1 | 200 | 0 | 0 | 0 | 85 * |
| 0.2 | 200 | 73 | 0 | 73 | 85 * |
| 0.1 | 100 | 0 | 0 | 0 | 85 * |
| 0.05 | 50 | 0 | 0 | 0 | 10 * |
| 0.4 | 200 | 89 | 0 | 89 | 93 * |
| 0.2 | 100 | 73 | 0 | 73 | 65 |
| 0.8 | 200 | 98 | 0 | 98 | 100 * |
| 0.4 | 100 | 89 | 0 | 89 | 90 * |
| 0.2 | 50 | 73 | 0 | 73 | 0 |
| 0.1 | 25 | 0 | 10 | 10 | 15 * |

TABLE 4

| PPM AI | | AVERAGE DEAD IN % | | EX- | OB- |
|---|---|---|---|---|---|
| COM- | | COM- | | PECTED | SERVED |
| POUND | Clothi- | POUND | Clothi- | CON- | CON- |
| I-A2 | anidin | I-A2 | anidin | TROL | TROL |
| 0.2 | 24 | 73 | 85 | 96 | 90 |
| 0.1 | 12 | 0 | 50 | 50 | 75 * |
| 0.05 | 6 | 0 | 25 | 25 | 10 |
| 0.2 | 12 | 73 | 50 | 86 | 80 |
| 0.1 | 6 | 0 | 25 | 25 | 65 * |
| 0.05 | 3 | 0 | 0 | 0 | 15 * |
| 0.2 | 6 | 73 | 25 | 79 | 75 |
| 0.1 | 3 | 0 | 0 | 0 | 60 * |
| 0.4 | 6 | 89 | 25 | 92 | 90 |
| 0.2 | 3 | 73 | 0 | 73 | 85 * |
| 0.8 | 6 | 98 | 25 | 98 | 98 |
| 0.4 | 3 | 89 | 0 | 89 | 93 * |
| 0.2 | 1.5 | 73 | 0 | 73 | 50 |

Tetranychus urticae (Two-Spotted Spider Mite)

Bean leaf discs on agar in 24-well microtiter plates are sprayed with test solutions (DMSO). After drying, the leaf discs are infested with mite populations of mixed ages. 8 days later, discs are checked for mixed population mortality. Application rates are as indicated in the Tables.

TABLE 5

| PPM AI | | AVERAGE DEAD IN % | | EX- | OB- |
|---|---|---|---|---|---|
| COM- | | COM- | | PECTED | SERVED |
| POUND | | POUND | | CON- | CON- |
| I-A2 | Abamectin | I-A2 | Abamectin | TROL | TROL |
| 0.4 | 0.2 | 100 | 60 | 100 | 90 |
| 0.2 | 0.1 | 83 | 55 | 93 | 80 |
| 0.1 | 0.05 | 17 | 55 | 63 | 65 * |
| 0.4 | 0.1 | 100 | 55 | 100 | 95 |
| 0.2 | 0.05 | 83 | 55 | 93 | 55 |
| 0.1 | 0.025 | 17 | 25 | 38 | 25 |
| 0.2 | 0.025 | 83 | 25 | 88 | 70 |
| 0.1 | 0.0125 | 17 | 0 | 17 | 10 |
| 0.4 | 0.025 | 100 | 25 | 100 | 95 |
| 0.2 | 0.0125 | 83 | 0 | 83 | 85 * |
| 0.4 | 0.0125 | 100 | 0 | 100 | 90 |

TABLE 6

| PPM AI | | AVERAGE DEAD IN % | | EX- | OB- |
|---|---|---|---|---|---|
| COM- | Lambda | COM- | Lambda | PECTED | SERVED |
| POUND | Cyhal- | POUND | Cyhal- | CON- | CON- |
| I-A2 | othrin | I-A2 | othrin | TROL | TROL |
| 0.2 | 50 | 83 | 85 | 98 | 100 * |
| 0.1 | 25 | 17 | 90 | 92 | 100 * |
| 0.2 | 25 | 83 | 90 | 98 | 100 * |
| 0.1 | 12.5 | 17 | 50 | 58 | 95 * |
| 0.2 | 12.5 | 83 | 50 | 92 | 95 * |
| 0.1 | 6.25 | 17 | 0 | 17 | 95 * |
| 0.8 | 25 | 100 | 90 | 100 | 95 |
| 0.2 | 6.25 | 83 | 0 | 83 | 95 * |

TABLE 7

| PPM AI | | AVERAGE DEAD IN % | | EX- | OB- |
|---|---|---|---|---|---|
| COM- | | COM- | | PECTED | SERVED |
| POUND | Spiro- | POUND | Spiro- | CON- | CON- |
| I-A2 | tetramat | I-A2 | tetramat | TROL | TROL |
| 0.4 | 200 | 95 | 90 | 100 | 100 * |
| 0.2 | 100 | 85 | 90 | 99 | 100 * |
| 0.1 | 50 | 0 | 90 | 90 | 95 * |
| 0.05 | 25 | 0 * | 85 | 85 | 95 * |
| 0.025 | 12.5 | 0 * | 75 | 75 | 95 * |
| 0.4 | 100 | 95 | 90 | 100 | 100 * |
| 0.2 | 50 | 85 | 90 | 99 | 100 * |
| 0.1 | 25 | 0 | 85 | 85 | 100 * |
| 0.05 | 12.5 | 0 * | 75 | 75 | 85 * |
| 0.4 | 50 | 95 | 90 | 100 | 100 * |
| 0.2 | 25 | 85 | 85 | 98 | 100 * |
| 0.1 | 12.5 | 0 | 75 | 75 | 80 * |
| 0.4 | 25 | 95 | 85 | 99 | 100 * |
| 0.2 | 12.5 | 85 | 75 | 96 | 95 |
| 0.4 | 12.5 | 95 | 75 | 99 | 100 * |

TABLE 8

| PPM AI | | AVERAGE DEAD IN % | | EX- | OB- |
|---|---|---|---|---|---|
| COM- | | COM- | | PECTED | SERVED |
| POUND | Clothi- | POUND | Clothi- | CON- | CON- |
| I-A2 | anidin | I-A2 | anidin | TROL | TROL |
| 0.4 | 800 | 95 | 0 | 95 | 100 * |
| 0.2 | 400 | 85 | 0 | 85 | 90 * |
| 0.1 | 200 | 0 | 0 | 0 | 85 * |
| 0.4 | 400 | 95 | 0 | 95 | 100 * |
| 0.2 | 200 | 85 | 0 | 85 | 100 * |
| 0.1 | 100 | 0 | 0 | 0 | 80 * |
| 0.4 | 200 | 95 | 0 | 95 | 100 * |
| 0.2 | 100 | 85 | 0 | 85 | 90 * |
| 0.1 | 50 | 0 | 0 | 0 | 65 * |
| 0.4 | 100 | 95 | 0 | 95 | 100 * |
| 0.2 | 50 | 85 | 0 | 85 | 95 * |
| 0.4 | 50 | 95 | 0 | 95 | 100 * |

A value of 0 * indicates that 0% control was assumed in view of the fact that control at the higher rate was also 0%.

Data is not shown for experiments where there was no control or where one compound and the combination of compounds controlled 100%.

What is claimed is:

1. A pesticidal mixture comprising a component A and a component B, wherein component A is an enantiomeric mixture of a compound of formula I that is enantiomerically enriched for the S enantiomer 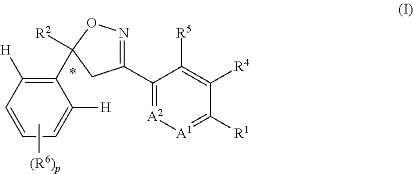
wherein the symbol * indicates the chiral centre;
A¹ and A² are C—H, or one of A¹ and A² is C—H and the other is N;
R¹ is a group selected from P1 to P38 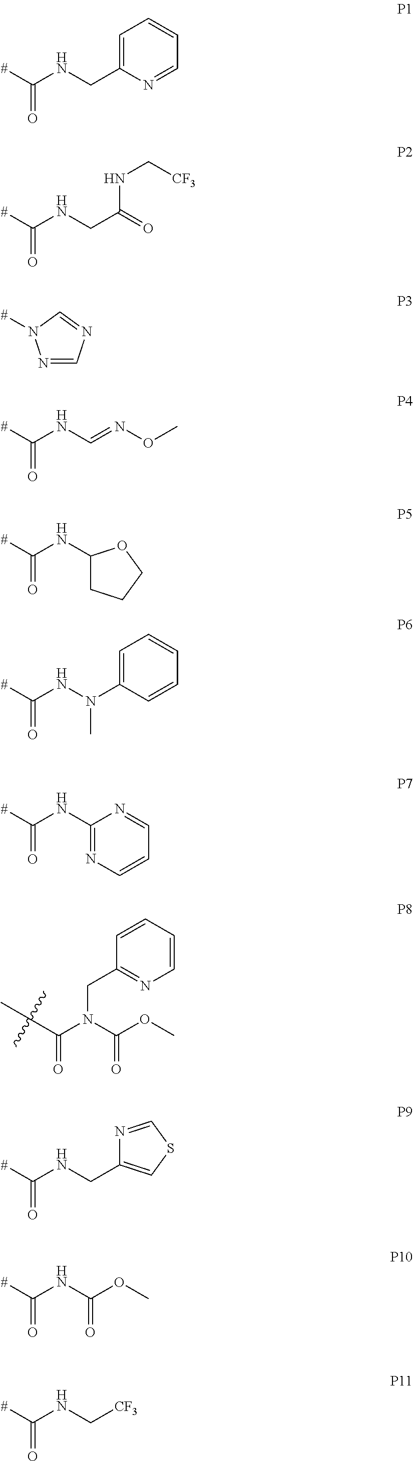 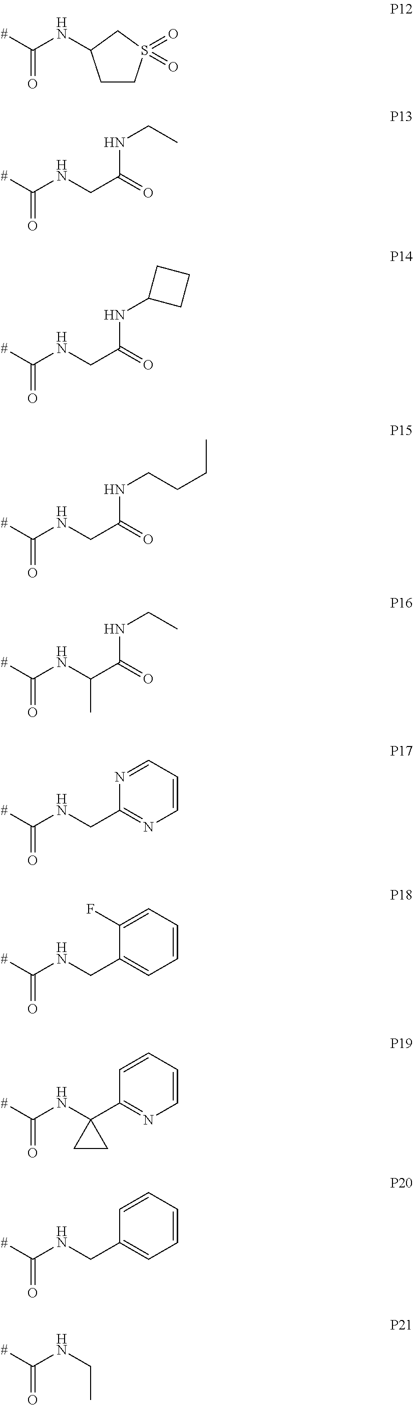 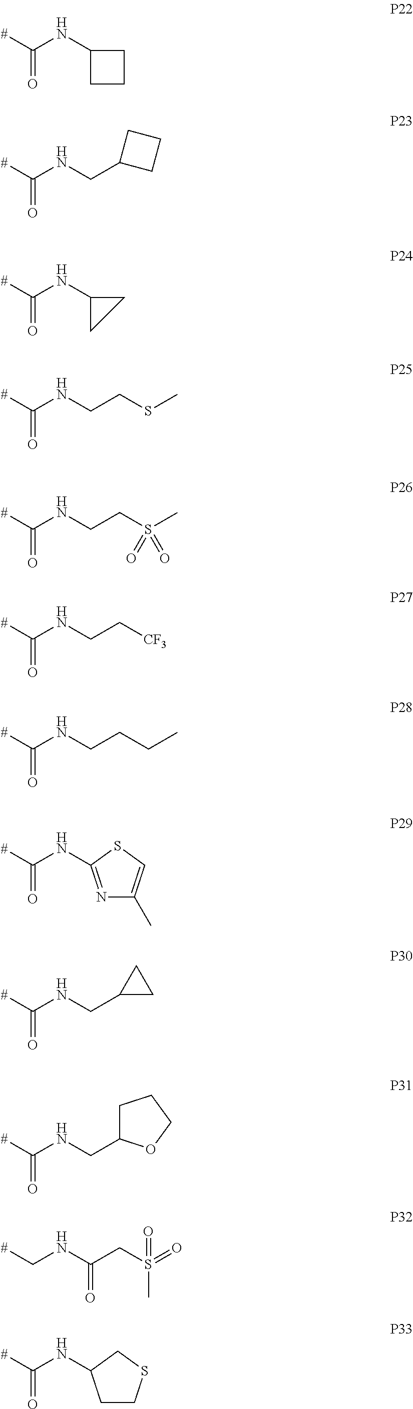 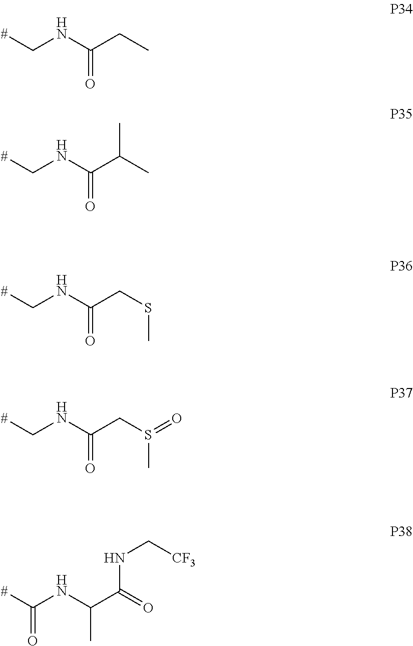
R² is chlorodifluoromethyl or trifluoromethyl;
R⁴ is hydrogen, halogen, methyl, halomethyl or cyano;
R⁵ is hydrogen;
or R⁴ and R⁵ together form a bridging 1,3-butadiene group;
each R⁶ is independently bromo, chloro, fluoro or trifluoromethyl;
p is 2 or 3;
and component B is a compound selected from
a) a pyrethroid including those selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
b) an organophosphate including those selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
c) a carbamate including those selected from the group consisting of pirimicarb, triazamate, cloethocarb, carbofuran, furathiocarb, ethiofencarb, aldicarb, thiofurox, carbosulfan, bendiocarb, fenobucarb, propoxur, methomyl and oxamyl;
d) a benzoyl urea including those selected from the group consisting of diflubenzuron, triflumuron, hexaflumuron, flufenoxuron, lufenuron and chlorfluazuron;
e) an organic tin compound selected from the group consisting of cyhexatin, fenbutatin oxide and azocyclotin;
f) a pyrazole including those selected from the group consisting of tebufenpyrad and fenpyroximate;
g) a macrolide including those selected from the group consisting of abamectin, emamectin (e.g. emamectin benzoate), ivermectin, milbemycin, spinosad, azadirachtin and spinetoram;
h) an organochlorine compound including those selected from the group consisting of endosulfan (in particular alpha-endosulfan), benzene hexachloride, DDT, chlordane and dieldrin;
i) an amidine including those selected from the group consisting of chlordimeform and amitraz;
j) a fumigant agent including those selected from the group consisting of chloropicrin, dichloropropane, methyl bromide and metam;
k) a neonicotinoid compound including those selected from the group consisting of imidacloprid, thiacloprid, acetamiprid, nitenpyram, dinotefuran, thiamethoxam, clothianidin, nithiazine and flonicamid;
l) a diacylhydrazine including those selected from the group consisting of tebufenozide, chromafenozide and methoxyfenozide;
m) a diphenyl ether including those selected from the group consisting of diofenolan and pyriproxyfen;
n) indoxacarb;
o) chlorfenapyr;
p) pymetrozine;
q) a tetramic acid compound including those selected from the group consisting of spirotetramat and spirodiclofen, or a tetronic acid compound including including spiromesifen;
r) a diamide including those selected from the group consisting of flubendiamide, chlorantraniliprole (Rynaxypyr®) and cyantraniliprole;
s) sulfoxaflor;
t) metaflumizone;
u) fipronil and ethiprole;
v) pyrifluqinazon;
w) buprofezin;
x) diafenthiuron;
y) 4-[(6-Chloro-pyridin-3-ylmethyl)-(2,2-difluoro-ethyl)-amino]-5H-furan-2-one; and
z) Bacillus firmus, Bacillus cereus, Bacillus subtilis, and Pasteuria penetrans.

2. A pesticidal mixture according to claim 1, wherein the compound of formula I is a compound of formula IA 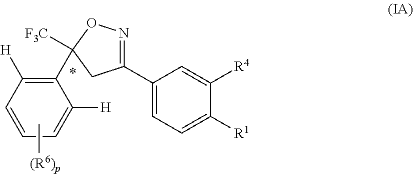
wherein the symbol * indicates the chiral centre;
R¹ is P1 or P2;
R⁴ is chloro, bromo, CF₃ or methyl;
each R⁶ is independently bromo, chloro, fluoro or trifluoromethyl; and
p is 2 or 3.

3. A pesticidal mixture according to claim 1, wherein the compound of formula I is a compound of formula IB 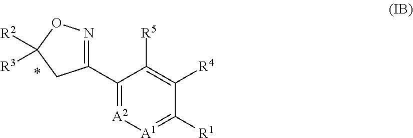
wherein the symbol * indicates the chiral centre;
A¹ and A² are C—H, or one of A¹ and A² is C—H and the other is N;
R¹ is a group selected from P1 to P11;
R² is chlorodifluoromethyl or trifluoromethyl;
R³ is 3,5-dibromo-phenyl, 3,5-dichloro-phenyl, 3,4-dichloro-phenyl, 3,5-dichloro-4-fluoro-phenyl or 3,4,5-trichloro-phenyl;
R⁴ is hydrogen, methyl or cyano;
R⁵ is hydrogen;
or R⁴ and R⁵ together form a bridging 1,3-butadiene group.

4. A pesticidal mixture according to claim 1, wherein the compound of formula I is a compound of formula I-A2 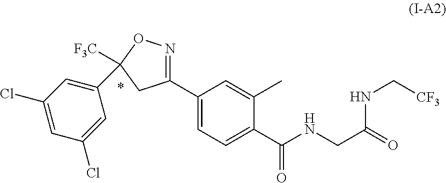 [SMILES: Cc1cc(C2=NOC(c3cc(Cl)cc(Cl)c3)(C(F)(F)F)C2)ccc1C(=O)NCC(=O)NCC(F)(F)F]
wherein the symbol * indicates the chiral centre.

5. A pesticidal mixture according to claim 1, wherein component A is at least 80% enantiomerically enriched for the S enantiomer.

6. A pesticidal mixture according to claim 1, wherein component A is at least 90% enantiomerically enriched for the S enantiomer.

7. A pesticidal mixture according to claim 1, wherein component B is a compound selected from
a macrolide compound including those selected from the group consisting of abamectin, emamectin (e.g. emamectin benzoate), ivermectin, milbemycin, spinosad, azadirachtin and spinetoram;
a neonicotinoid compound including those selected from the group consisting of imidacloprid, thiacloprid, acetamiprid, nitenpyram, dinotefuran, thiamethoxam, clothianidin, nithiazine and flonicamid;
a pyrethroid compound including those selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate; and
a tetramic acid compound including those selected from the group consisting of spirotetramat and spirodiclofen.

8. A pesticidal mixture according to claim 1, wherein component B is a compound selected from the group consisting of abamectin, lambda cyhalothrin, spirotetramat, and clothianidin.

9. A pesticidal mixture according to claim 1, wherein component B is a tetramic acid compound including those selected from the group consisting of spirotetramat and spirodiclofen.

10. A pesticidal mixture according to claim 1, wherein component B is spirotetramat.

11. A pesticidal mixture according to claim 1, wherein the mixture comprises an agricultural acceptable carrier and optionally a surfactant.

12. A pesticidal mixture according to claim 1, wherein the weight ratio of A to B is 1000:1 to 1:1000.

13. A method of controlling insects, acarines, nematodes or molluscs which comprises applying to a pest, to a locus of a pest, or to a plant susceptible to attack by a pest a combination of components A and B, wherein components A and B are as defined in claim.

14. A seed comprising a mixture as defined in claim 1.

15. A method comprising coating a seed with a mixture as defined in claim 1.
